(19) United States
(12) Patent Application Publication
(10) Pub. No.: US 2001/0015400 A1
(43) Pub. Date: Aug. 23, 2001

(54) Adjusting apparatus

(76) Inventor: Christopher James Langham, Bishops Stortford (GB)

Correspondence Address: FLYNN, THIEL, BOUTELL & TANIS, P.C., 2026 Rambling Road, Kalamazoo, MI, 49008-1699, US

(21) Appl. No.: 09/790,089

(22) Filed: Feb. 21, 2001

(30) Foreign Application Priority Data
Feb. 21, 2000 (GB) 0004063.4

(51) Int. Cl. F16M 13/00

(52) U.S. Cl. 248/425; 248/157; 248/408

(57) ABSTRACT

The invention relates to apparatus for adjusting the angular position of one member relative to another, comprising means releasably lockably engageable with the one member therefor whereby the means is operable to lock and unlock the one member with respect to the another member. There is a remote actuating means for the means.

The members may form the pedestal for supporting a seat which can be adjusted in height, angular position and tilt, and locked by the apparatus in a desired adjusted position which is particularly suitable for users with special needs.

The invention relates to adjusting apparatus, and particularly to such apparatus for adjusting the position of one member relative to another.

Swivel pedestal chairs are known, the seat being mounted on a pedestal which usually comprises two tubes one of which mounts the seat so that the seat can be rotated relative to the other, which is usually fixedly mounted to a base of the chair. Thus the seat can be adjusted in its angular position with respect to the (fixed) tube and base.

Usually, the seat is adjusted to the required angular position by the user before he or she sits down on the chair. However, it is often the case that the seat swivels in the act of mounting, or indeed dismounting from the chair. Whilst this annoying disadvantage can usually readily be overcome by an able-bodied user, particularly an adult, when sitting on the seat, although some time and effort is expended in so doing, this is not the case with users, particularly children, who have some physical disability such as back problems. The tendency of the seat of the chair to swivel is a disadvantage which can be serious in that use of the chair can become dangerous as a user can fall off, so leading to distress and perhaps additional physical injury. Where the seat is used in an institution, say a hospital, there may be implications in that higher insurance premiums for injury or negligence become payable. There is thus a requirement for a seat which is particularly applicable for use by those with special needs.

It is accordingly an object of the invention to seek to mitigate these disadvantages.

According to a first aspect of the invention, there is provided apparatus for adjusting the angular position of one member relative to another, comprising means releasably lockably engageable with the one member and remote actuating means therefor whereby the first-mentioned means is operable to lock and unlock the one member with respect to the another member.

The one member and the another member may be concentrically mounted for relative rotation, and the one member may be externally mounted with respect to the another member. This provides a relatively simple construction whilst allowing adjustment of angular position.

The means releasably lockably engageable with the one member may comprise reciprocable finger means, suitably a reciprocable finger device which may be biased towards a locked position of the one member by biasing means which may itself comprise a coil spring. This construction provides a relatively simple yet positive adjusting mechanism.

The finger device may in use be received in seating means of the one member. This provides positive operation, whilst being a relatively simple construction, particularly when the seating means may comprise a plurality of spaced apart circumferential holes through the one member. This provides for a plurality of adjusted positions.

The actuating means may comprise a manual operating device remote from the locking means and connected thereto by a flexible elongate member which may be a cable, chain or the like. This provides a positive action. The cable, chain or the like may be slidably housed in a housing such as a plastic sleeve.

According to a second aspect of the invention, there is provided a swivel chair mounted on a pedestal, the pedestal comprising one member and another member which are relatively rotatable to swivel a seat of the chair, there being apparatus as hereinbefore defined for locking and unlocking the one member with respect to the another member whereby to adjust the swivelled position of the seat of the chair.

Apparatus embodying the invention is hereinafter described, by way of example, with reference to the accompanying drawings.

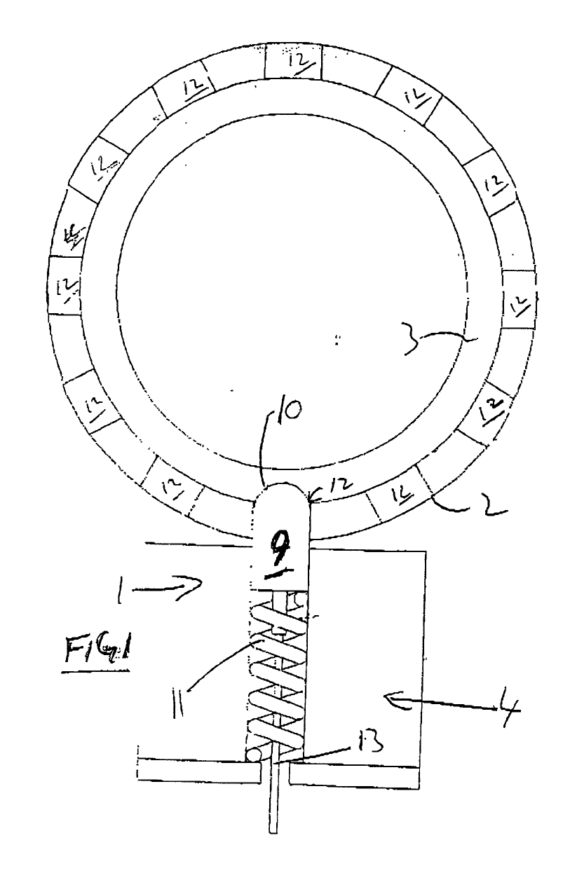

FIG. 1 is a schematic plan view of part of one embodiment of apparatus as used on a swivel chair;

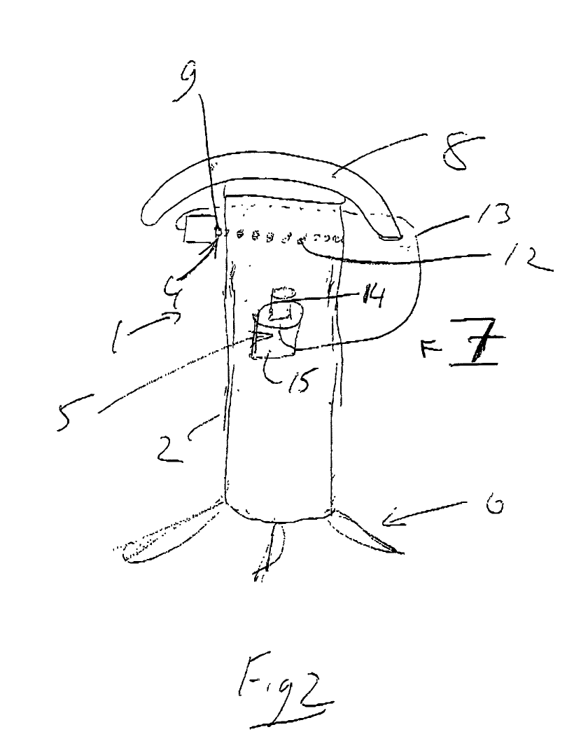

FIG. 2 is a schematic front elevational view of the apparatus of FIG. 1, to a smaller scale; and

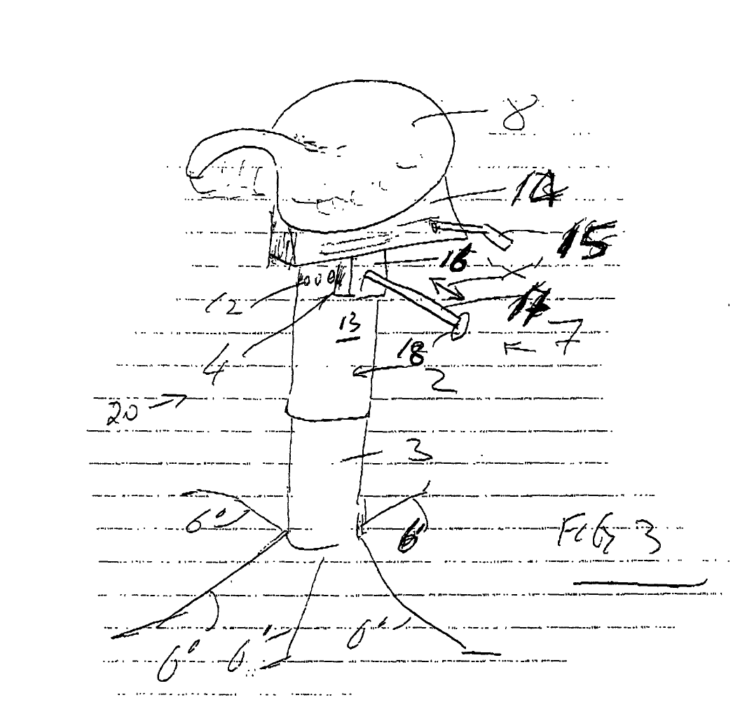

FIG. 3 is a schematic perspective view of a second embodiment of apparatus which is part of a swivel chair.

Referring to the drawings, in which like parts are shown by like reference numerals, there is shown apparatus 1 for adjusting the angular position of one member 2 relative to another 3, comprising means 4 releasably lockably engageable with the one member 2 therefor whereby the means 4 is operable to lock and unlock the one member 2 with respect to the another member 3. There is a remote actuating means 5 for the means 4.

In the embodiment of FIGS. 1 and 2 the one member 2 is an external tube mounted concentrically on, and rotatably and telescopically arranged with respect to, an inner tube or rod forming the another member 3 and which member 3 is fixed to a base 6, the two tubes forming a pedestal of a swivel chair 7, a seat 8 of which is mounted on the outer tube or one member 2. The member 3 is itself a piston and cylinder member to allow for raising and lowering of the seat 8 to a desired adjusted height.

The releasably lockably engageable means 4 comprises a housing mounted on a bracket (not shown) under the seat 8, there being detent means in the form of a finger device 9 with a bull-nosed free end 10 reciprocally slidably mounted in the housing 4 under pressure of a biassing means in the form of a coil tension spring 11 which biasses the finger device 9 to a locking position as shown in FIG. 1, there being seating means in the form of a plurality of circumferentially arranged and spaced apart through holes 12 in the external tube 2 each of a diameter to receive the free end 10 of the finger device 9 in a close fit.

An end of the finger device 9 remote from the free end 10 is connected to a relatively rigid yet flexible elongate member 13 such as a cable, chain or the like, running in a sleeve (also not shown) for smoothness of operation and aesthetic effect. The other end of the cable, chain or the like 13 is attached to the actuating means 5 in the form of a mechanism operated by a push button or plunger 14 held in a housing 15 fixedly mounted to a bracket (not shown) at the front (usually) of the chair 7. The plunger 14 when actuated operates a crank or toggle device in the housing 15 to which the cable 13 is connected so that on pushing the plunger 14, the cable 13 is effectively shortened, so pulling the finger device 9 against the pressure of the spring 11 into the housing 4 and freeing the free end 10 from a hole 12 in which it is located. The angular position of the seat 8 can then be adjusted to a desired position by swivelling the seat, the one member 2 rotating on the another member 3. When in the desired position, releasing the plunger 14 enables the spring 11 to extend the finger device 9 so that its free end 10 engages in a new facing hole 12 to lock the seat 8 in the required position.

Referring now to the embodiment of FIG. 3, there is shown a swivel chair 7 having a seat 8, which is mounted for vertical height adjustment as described with reference to FIGS. 1 and 2, on an inner or another member or tube 3 which has at an end remote from the seat 8, a base 6 in the form of a plurality of feet 6′. Mounted externally of the tube 3 is the one member 2 in the form of a sleeve 13 which has at the upper end as viewed a plurality of circumferentially arranged and spaced apart through holes 12. The sleeve 13 has an upper inwardly directed flange which seats on the upper end of the member on tube 3, so that the sleeve 13 can rise and sink with a member, usually the piston, of the piston and cylinder construction of the member 3. The seat 8 is supported on the upper end of the tube 3, on the piston part thereof in the embodiment by a boss or support 14 which connects the tube 3 and the seat 8. The boss or support 14 mounts levers such as the one 15 shown for operating a raise and lowering mechanism (not shown, the piston and cylinder arrangement of the tube 3) and for adjusting the tilt of the seat 8 in a fore and aft direction. The seat 8 is thus pivotably mounted on the boss or support 14 for allowing such fore and aft tilting as desired. However, it is often necessary, particularly for special needs patients, for the seat 8 to be locked in a desired position, in other words so that it cannot swivel, raise, lower or tilt particularly when being mounted or demounted. This is achieved by apparatus comprising a bracket 16 depending from the boss or support 14 and in which is captively mounted an actuating mechanism in the form of a push pull rod 17 which has a detent (not shown) in the form of a free end thereto which can pass out of the bracket 16 to engage a selected hole to lock the seat 8 in a desired pre-adjusted position. The rod 17 has a remote actuating means in the form of a manually grippable handle 18 at one end, for operation to and fro as shown by the arrow ‘X’.

In operation, with the handle rod 17 withdrawn so that no hole 12 is engaged, the seat 8 is adjusted to a desired height, tilt and angular position using the respective mechanisms and handles 15. When in the desired position, the rod 17 is pushed in, i.e. towards the member 2, 3 so that its free end engages in a facing hole 12 so locking the seat 8 in the desired position.

When the position(s) of the seat 8 is next adjusted, the rod 17 is withdrawn to disengage from the hole 12, so allowing adjustment of the seat 8 to a new desired position. The rod 17 is then pushed back in to engage another hole 12 in the newly adjusted position so that the seat 8 is locked in that new position.

It will be understood that in both embodiments, as the housing 4 is mounted on a bracket under the seat 8 telescopic height adjustment of the seat by raising it on the tube 2 over tube 3 is also possible whilst allowing lockable angular adjustment as hereinbefore described. The raising may be by a gas lift device, also not shown, which forms part of the piston and cylinder construction of the member 3.

It will be understood that a chair using the apparatus described with reference to the drawings can be swivelled, yet undesired swivelling during mounting or dismounting therefrom is obviated, so being beneficial particularly for special needs users.

I claim:

1. Apparatus for adjusting the angular position of one member relative to another, comprising:
(i) means releasably lockably engageable with said one member, and
(ii) remote actuating means for said first-mentioned means whereby said first-mentioned means is operable to lock and unlock the one member for movement with respect to the another member.

2. Apparatus as defined in claim 1, wherein the one member and the another member are concentrically mounted for relative rotation and wherein the one member is externally mounted with respect to the another member.

3. Apparatus as defined in claim 1, wherein the means releasably lockably engageable with said one member comprises reciprocable detent means.

4. Apparatus as defined in claim 3, wherein the detent means comprises a reciprocable finger device.

5. Apparatus as defined in claim 3, wherein the said detent means comprises a finger device biassed towards a locked position of said one member, and wherein there is by biassing means for effecting said biassing action.

6. Apparatus as defined in claim 5, wherein said biassing means comprises a coil spring.

7. Apparatus as defined in claim 3, wherein a free end of the detent means is received in use in seating means of the one member.

8. Apparatus as defined in claim 3, wherein the one member carries a plurality of spaced apart circumferential holes comprising said seating means.

9. Apparatus as defined in claim 1, wherein the actuating means comprises a manual operating device remote from the locking means and connected thereto by a flexible elongate member.

10. Apparatus as defined in claim 9, wherein the flexible elongate member comprises a cable.

11. Apparatus as defined in claim 10, wherein the cable is slidable in a housing.

12. A swivel chair having a seat mounted on a pedestal, the pedestal comprising one member and another member which are relatively rotatable to swivel the seat of the chair, comprising:
(i) apparatus as defined in claim 1 for locking and unlocking the one member with respect to the another member whereby to adjust the swivelled position of the seat of the chair.

13. A swivel chair as defined in claim 12, wherein the one member and the other member are telescopically mounted for vertical reciprocation.

14. A swivel chair as defined in claim 1, the seat being mounted on the inner member of the one and another member.
